(19) United States
(12) Patent Application Publication
(10) Pub. No.: US 2013/0169760 A1
(43) Pub. Date: Jul. 4, 2013

(54) Image Enhancement Methods And Systems

(71) Applicant: Lloyd Watts, Mountain View, CA (US)

(72) Inventor: Lloyd Watts, Mountain View, CA (US)

(21) Appl. No.: 13/719,079

(22) Filed: Dec. 18, 2012

Related U.S. Application Data
(60) Provisional application No. 61/583,144, filed on Jan. 4, 2012.
(60) Provisional application No. 61/590,656, filed on Jan. 25, 2012.

(51) Int. Cl. G06K 9/40; G06T 7/00; H04N 13/02; G06K 9/46

(52) U.S. Cl. CPC G06K 9/40; G06K 9/46; G06T 7/0075; H04N 13/02
USPC 348/47; 382/195; 382/154

(57) ABSTRACT

Provided are computer-implemented systems and methods for image enhancement using one or more image processing techniques, such as stereo disparity, facial recognition, and other like features. An image may be captured using one or two cameras provided on the same device. The image is then processed to detect at least one of a foreground portion or a background portion of the image. These portions are then processed independently from each other, for example, to enhance the foreground and/or blur the background. For example, a circular blur or a Gaussian blur technique may be applied to the background. The processing may be performed on still images and/or video images, such as live teleconferences. The processing may be performed on an image capturing device, such as a mobile phone, a tablet computer, or a laptop computer, or performed on a back-end system.

### CROSS-REFERENCE TO RELATED APPLICATIONS

This application claims the benefit of U.S. Provisional Patent Application No. 61/583,144, filed Jan. 4, 2012, and U.S. Provisional Patent Application No. 61/590,656, filed Jan. 25, 2012, both of which applications are incorporated herein by reference in their entirety.

### FIELD

This application relates generally to image enhancing and more specifically to computer-implemented systems and methods for image enhancement using one or more of stereo disparity, facial recognition, and other like features.

### BACKGROUND

Many modern mobile devices, such as smart phones and laptops, are equipped with cameras. However, the quality of photo and video images produced by these cameras is often less than desirable. One problem is the use of relatively inexpensive cameras in comparison, for example, with professional cameras. Another problem is a relatively small size of the mobile devices (the thickness of the mobile devices in particular) requires the optical lens to be small as well. Most of the mobile devices are equipped with a lens having a relatively small lens aperture that results in a large depth of field. As such, the background of the resulting image can be very distracting, competing for the viewer's attention since all objects are equally sharp.

### SUMMARY

Provided are computer-implemented systems and methods for image enhancement using one or more image processing techniques, such as stereo disparity, facial recognition, and/or other like features. An image may be captured using one or two cameras provided on the same device. The image is then processed to detect at least one of a foreground portion or a background portion of the image. These portions are then processed independently from each other, for example, to enhance the foreground and/or blur the background. For example, a Gaussian blur or circular blur technique can be applied to the background. The processing may be performed on still images and/or video images, such as live teleconferences. The processing may be performed on an image capturing device, such as a mobile phone, a tablet computer, or a laptop computer, or performed on a back-end system.

In some embodiments, a computer implemented method of processing an image involves detecting at least one of a foreground portion or a background portion of the image and processing at least one of the foreground portion and the background portion independently from each other. For example, the background portion may be processed (e.g., blurred), while the foreground portion may remain intact. In another example, the background portion may remain intact, while the foreground portion may be sharpened. In yet another example, both portions are processed and modified. The detecting operation separates the image into at least the foreground portion and the background portion. However, other portions of the image may be identified during this operation as well.

In some embodiments, the detecting involves utilizing one or more techniques, such as motion parallax (e.g., for video images), local focus, color grouping, and face detection. When the captured image is a stereo image produced by two cameras provided on the same device, the detecting may involve analyzing the stereo disparity to separate the background portion from the foreground portion. In one example, the detecting operation involves face detection.

In some embodiments, the processing operation involves one or more of the following techniques: changing sharpness as well as colorizing, suppressing, and changing saturation. Changing sharpness may be based on circular blurring. In another example, changing sharpness may involve Gaussian blurring. One of these techniques may be used for blurring the background portion of the image. The foreground portion may remain unchanged. In another example, the sharpness and/or contrast of the foreground portion of the image may be changed.

The image may be a frame of a video. In this example, some operations of the method (e.g., the detecting and processing operations) may be repeated for additional frames of the video.

In some embodiments, the method also involves capturing the image. The image may be captured using a single camera or, more specifically, a single lens. In other embodiments, a captured image may be a stereo image, which may include two images (e.g., left and right images, or top and bottom images, and similar variations). The stereo image may be captured using two separate cameras provided on the same device and arranged in accordance to the type of stereo image. In some embodiments, the two cameras are positioned side by side within a horizontal plane. The two cameras may be separated by between about 30 millimeters and 150 millimeters.

Also provided are computer implemented methods of processing an image involving capturing the image, detecting at least one of a foreground portion or a background portion of the image based on stereo disparity of the image, processing at least one of the foreground portion and the background portion independently from each other, and displaying the processed image. The image is a stereo image captured by two cameras provided on the same device. The detecting operation separates the image into at least the foreground portion and the background portion. Processing may involve blurring the background portion of the image.

Provided also is a device for capturing and processing an image. The device may include a first camera, a second camera separated from the first camera by between about 30 millimeters and 150 millimeters, a processing module, and a storage module. The first camera and the second camera may be configured to capture a stereo image. The processing module may be configured for detecting at least one of a foreground portion or a background portion of the stereo image and for processing at least one of the foreground portion and the background portion independently from each other. As noted above, the detecting separates the stereo image into at least the foreground portion and the background portion. The storage module may be configured for storing the stereo image, the processed images, and one or more settings used for the detecting and processing operations. Some examples of such devices include a specially configured cell phone, a specially configured digital camera, a specially configured digital tablet computer, a specially configured laptop computer, and the like.

### BRIEF DESCRIPTION OF THE DRAWINGS

FIG. 1 illustrates a schematic representation of an unprocessed image, in accordance with some embodiments.

FIG. 2 illustrates a schematic representation of a processed image, in accordance with some embodiments.

FIG. 3 illustrates a top view of a device equipped with two cameras and an object positioned on a foreground, in accordance with some embodiments.

FIG. 4 is a process flowchart of a method for processing an image, in accordance with some embodiments.

FIG. 5A is a schematic representation of various modules of an image capturing and processing device, in accordance with some embodiments.

FIG. 5B is a schematic process flow utilizing a device with two cameras, in accordance with some embodiments.

FIG. 5C is a schematic process flow utilizing a device with one camera, in accordance with some embodiments.

FIG. 6 is a diagrammatic representation of an example machine in the form of a computer system, within which a set of instructions for causing the machine to perform any one or more of the methodologies discussed herein may be executed.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### Introduction

Many modern devices are equipped with cameras, which provide additional functionality to these devices. At the same times, the devices are getting progressively smaller to make their use more convenient. Examples include camera phones, tablet computers, laptop computers, digital cameras, and other like devices. A camera phone example will now be briefly described to provide some context to this disclosure. A camera phone is a mobile phone, which is able to capture images, such as still photographs and/or video. Currently, the majority of mobile phones in use are camera phones. The camera phones include cameras that are typically simpler than standalone digital cameras, in particular, high end digital cameras such as Digital Single-Lens Reflex (DSLR) camera. The camera phones are typically equipped with fixed focus lenses and smaller sensors, which limit their performance. Furthermore, the camera phones typically lack a physical shutter resulting in a long shutter lag. Optical zoom is rare.

Yet, camera phones are extremely popular for taking still pictures and videos, and conducting teleconferences, due to their availability, connectivity, and various additional features. For examples, some camera phones provide geo-tagging and image stitching features. Some camera phones provide a touch screen to allow users to direct their camera to focus on a particular object in the field of view, giving even an inexperienced user a degree of focus control exceeded only by seasoned photographers using manual focus.

Yet, cost and size constrains limit optical features that can be implemented on the above referenced devices. Specifically, the thin form-factors of many devices make it very difficult to use long lenses with wide apertures for capturing high-quality, limited-depth-of-field effects (i.e., sharp subject, blurry background). For this reason, typical pictures shot with camera phones have the entire scene in sharp focus, rather than having a sharply-focused subject with a pleasantly blurry background.

The described methods and systems allow such thin form-factor devices equipped with one or more short lens cameras to simulate limited-depth-of-field images with specific processing of images. Specifically, the methods involve detecting background and foreground portions of the image and selectively processing one or both of these portions. For example, the background portion may be blurred. In some embodiments, the background portion may be darkened, lightened, desaturated, saturated, subjected to color changes and other like operations. The foreground portion of the image may be subjected to contrast enhancement and/or sharpening, saturation, desaturation, etc.

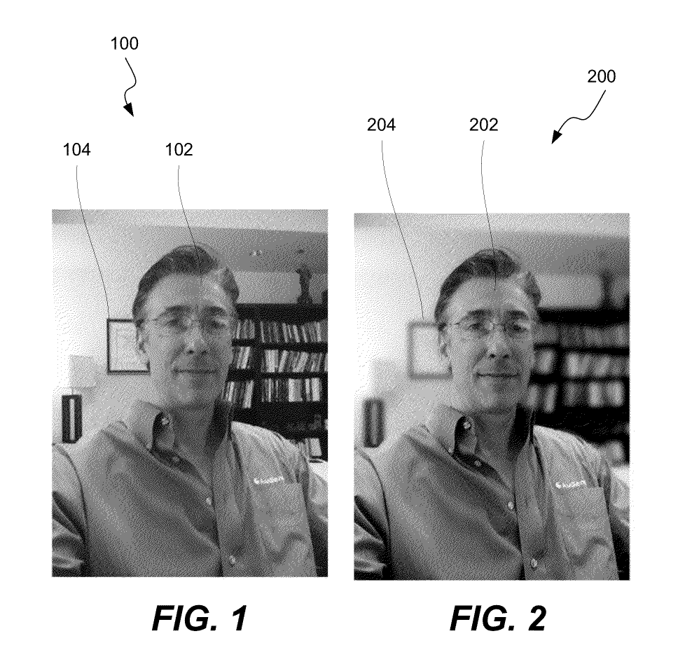

FIG. 1 illustrates a schematic representation of an unprocessed image 100, in accordance with some embodiments. The image 100 includes a foreground portion 102 and a background portion 104. Before processing, both portions 102 and 104 are in comparable focus, and background portion 104 may be distracting during viewing of this unprocessed image, competing for the viewer's attention.

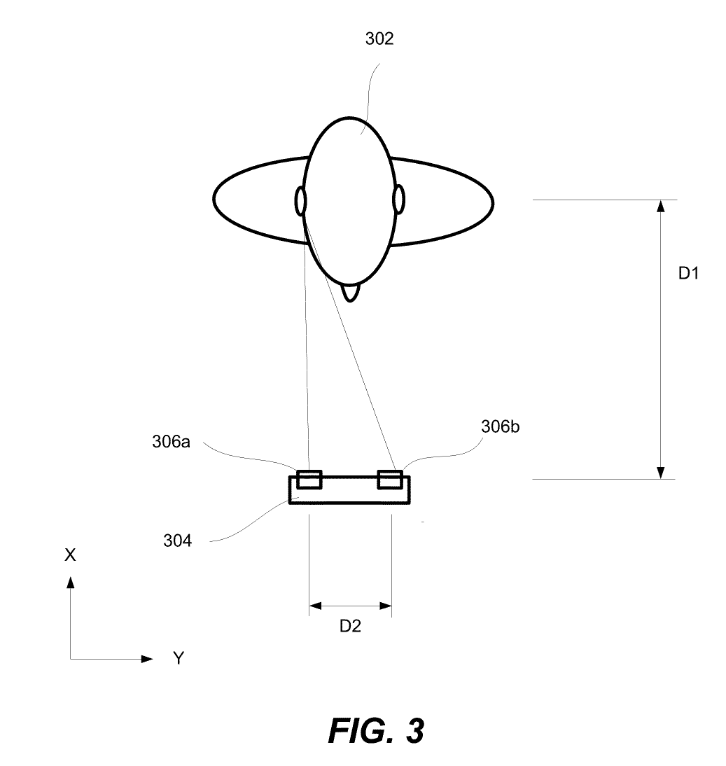

FIG. 2 illustrates a schematic representation of a processed image 200, in accordance with some embodiments. Processed image 200 is derived from unprocessed image 100 by enhancing the foreground portion 202 and suppressing the background portion 204. Suppressing background may involve blurring background, sharpening background, enhancing the contrast of background, darkening background, lightening background, desaturating or saturating background, despeckling background, adding noise to background, and the like. Enhancing foreground may involve sharpening foreground, blurring foreground, contrast enhancing of foreground, darkening foreground, lightening foreground, desaturating or saturating foreground, despeckling foreground, adding or removing noise to or from foreground, and the like.

In some embodiments, a device for capturing an image for further processing includes two cameras. The two cameras may be configured to capture a stereo image having stereo disparity. The disparity may, in turn, be used to detect the location of objects relative to the focal plane of the two cameras. The determination may involve the use of face detection. Typically, some post-processing of the foreground and background regions will be needed to obtain reliable segmentation at difficult edges (i.e., hair, shiny materials, etc.) Once the foreground and background regions have been determined, the background and foreground regions can be independently modified (i.e., sharpened, blurred, contrast enhanced, colorized, suppressed, saturated, desaturated, etc.).

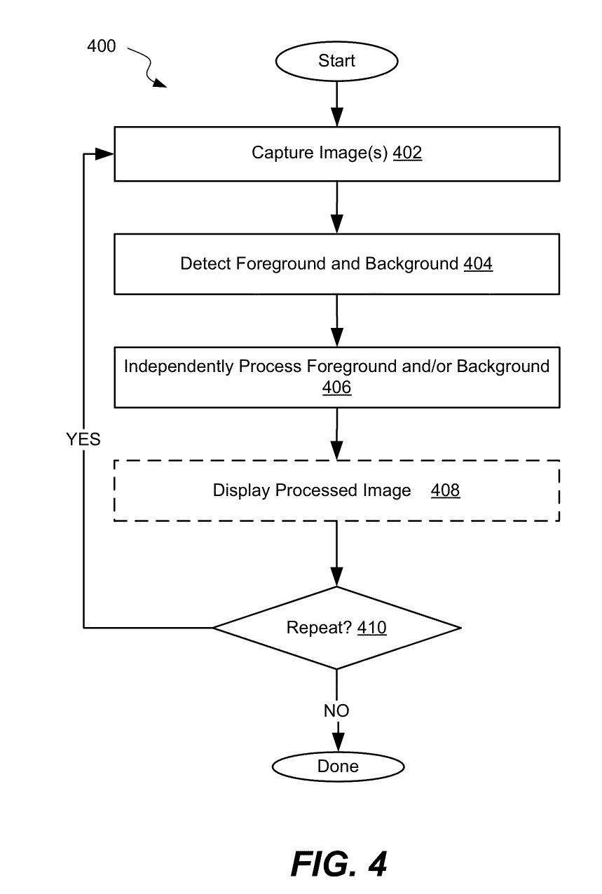

FIG. 3 illustrates a top view of a device 304 equipped with two cameras 306a and 306b, in accordance with some embodiments. The figure also illustrates an object 302 on the foreground. The suitable distance (D2) between the two cameras 306a and 306b may depend on the size and features of object 302 as well as the distance (D1) between cameras 306a and 306b and object 302. It has been found that for a typical operation of a camera phone and a portable computer system (e.g., a laptop, a tablet), which are normally positioned between 12″ and 36″ from a user's face, the distance between the two cameras could be between about 30 millimeters and 150 millimeters. Smaller distances between the cameras are generally not sufficient to provide enough stereo disparity, while larger distances may provide too much disparity for nearby subjects.

It should be noted that techniques described herein can be used for both still and moving images (e.g., video conferencing on smart-phones, personal computers, or video conferencing terminals). It should be also noted that a single-camera can be used for capturing for analysis. Various image cues can be used to determine the foreground and background region if, for example, the image does not have stereo disparity characteristics. Some examples of these cues include motion parallax (in video context), local focus, color grouping, face detection, and the like

### Examples of Image Processing Methods

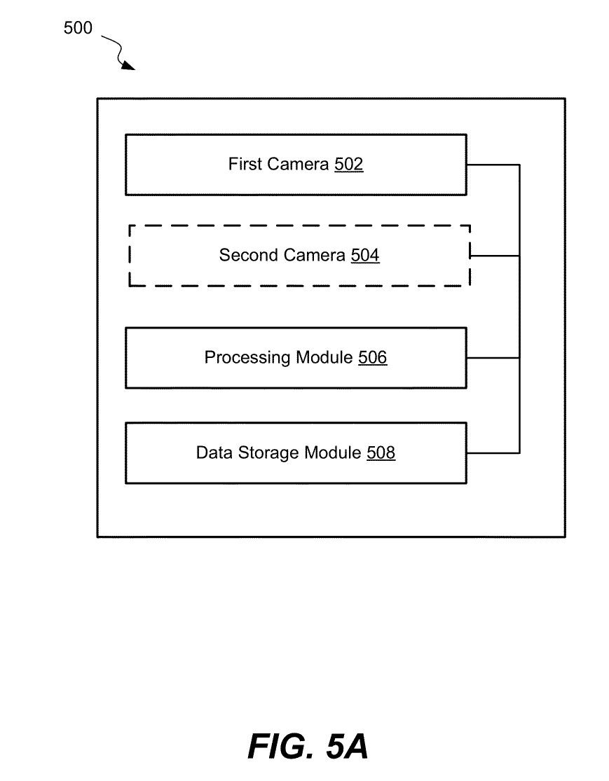

FIG. 4 is a process flowchart of a method 400 for processing an image, in accordance with some embodiments. Method 400 may commence with capturing one or more images during operation 402. In some embodiments, multiple cameras are used to capture different images. Various examples of image capturing devices having multiple cameras are described above with reference to FIG. 3. In other embodiments, the same camera may be used to capture multiple images, for example, with different focus settings. Multiple images used in the same processing should be distinguished from multiple images processed sequentially as, for example, during processing of video images.

It should be noted that an image capturing device may be physically separated from an image processing device. These devices may be connected using a network, a cable, or some other means. In some embodiments, the image capturing device and the image processing device may operate independently and may have no direct connection. For example, an image may be captured and stored for a period of time. At some later time, the image may be processed when it is so desired by a user. In a specific example, image processing functions may be provided as a part of a graphic software package.

In some embodiments, two images may be captured during operation 402 by different cameras or, more specifically, different optical lenses provided on the same device. These images may be referred to as stereo images. The two cameras/lenses may be positioned side by side within a horizontal plane as described above with reference to FIG. 3. Alternatively, the two cameras may be positioned along a vertical axis. The vertical and horizontal orientations are with reference to the orientation of the image. In some embodiments, the two cameras are separated by between about 30 millimeters and 150 millimeters. One or more images captured during operation 402 may be captured using a camera with a large depth of field from having a small aperture. In other words, this camera may provide very little depth separation, and both background and foreground portions of the image may have similar sharpness.

Method 400 may proceed with detecting at least one of a foreground portion or a background portion of the one or more images during operation 404. This detecting operation may be based on one or more of the following techniques: motion parallax, local focus, color grouping, and face detection. These techniques will now be described in more detail.

The motion parallax may be used for video images. It is a depth cue that results from a relative motion of objects captured in the image and the capturing device. In general, a parallax is a displacement or difference in the apparent position of an object viewed along two different lines of sight. It may be represented by the angle or semi-angle of inclination between those two lines. Nearby objects have a larger parallax than more distant objects when observed from different positions, which allows using the parallax values to determine distances and separate foreground and background portions of an image.

The face detection technique determines the locations and sizes of human faces in arbitrary images. Face detection techniques are well known in the art, see e.g., G. Bradski, A. Kaehler, “Learning OpenCV”, September 2008, incorporated by reference herein. Open Source Computer Vision Library (OpenCV) provides an open source library of programming functions mainly directed to real-time computer vision and cover various application areas including face recognition (including face detection) and stereopsis (including stereo disparity), and therefore such well known programming functions and techniques will not be described in all details here. According to a non limiting example, a classifier may be used according to various approach to classify portions of an image as either face or non-face.

In some embodiments, the image processed during operation 404 includes stereo disparity. Stereo disparity is the difference between corresponding points on left and right images and is well known in the art, see e.g., M. Okutomi, T. Kanade, “A Multiple-Baseline Stereo”, IEEE Transactions on Pattern Analysis and Machine Intelligence, April 1993, Vol. 15 no. 4, incorporated by reference herein, and will therefore not be described in all details here. As described above, the OpenCV library provides programming functions directed to stereo disparity.

The stereo disparity may be used during detecting operation 404 to determine proximity of each pixel or patch in the stereo images to the camera and therefore to identify the background and foreground portions of the image.

Detecting operation 404 also involves separating the image into at least the foreground portion and the background portion. In some embodiments, other image portion types may be identified, such as a face portion and an intermediate portion (i.e., a portion between the foreground and background portion). The purpose of separating the original image into multiple portions is so that at least one of these portions can be processed independently from other portions.

Once the foreground portion and the background portion are identified, method 400 proceeds at operation 406 with processing at least one of these portions independently from the other one. In some embodiments, the background portion is processed (e.g., blurred) while the foreground portion remains unchanged. In other embodiments, the background portion remains unchanged, while the foreground portion is processed (e.g., sharpened). In still other embodiments, both foreground and background portions are processed but in different manners. As noted above, the image may contain other portions (i.e., in addition to the background and foreground portions) that may be also processed in a different manner from the background portion, the foreground portion, or both.

The processing may involve one or more of the following techniques: defocussing (i.e., blurring), changing sharpness, changing colors, suppressing, and changing saturation. Blurring may be based on different techniques, such as a circular blur or a Gaussian blur. Blurring techniques are well known in the art, see e.g., G. Bradski, A. Kaehler, “Learning OpenCV”, September 2008, incorporated by reference herein, wherein blurring is also called smoothing, and Potmesil, M.; Chakravarty, I. (1982), “Synthetic Image Generation with a Lens and Aperture Camera Model”, ACM Transactions on Graphics, 1, ACM, pp. 85-108, incorporated by reference herein, which also describes various blur generation techniques. In some embodiments, an elliptical or box blur may be used.

The Gaussian blur, which is sometimes referred to as Gaussian smoothing, uses a Gaussian function to blur the image. The Gaussian blur is known in the art, see e.g., “Learning OpenCV”, ibid.

In some embodiments, the image is processed such that sharpness is changed for the foreground or background portion of the image. Changing sharpness of the image may involve changing the edge contrast of the image. The sharpness changes may involve low-pass filtering and resampling.

In some embodiments, the image is processed such that the background portion of the image is blurred. This reduces distraction and focuses attention on the foreground. The foreground portion may remain unchanged. Alternatively, blurring the background accompanies sharpening the foreground portion of the image.

In some embodiments, the processed image is displayed to a user, as reflected by optional operation 408. The user may choose to perform additional adjustments by, for example, changing the settings used during operation 406. These settings may be used for future processing of other images. The processed image may be displayed on the device used to capture the original image (during operation 402) or some other device. For example, the processed image may be transmitted to another computer system as a part of teleconferencing.

In some embodiments, the image is a frame of a video (e.g., a real time video used in the context of video conferencing). Operations 402, 404, and 406 may be repeated for each frame of the video as reflected by decision block 410. In this case, the same settings may be used for most frames in the video. Furthermore, results of certain processes (e.g., face detection) may be adapted for other frames.

### Image Processing Apparatus Examples

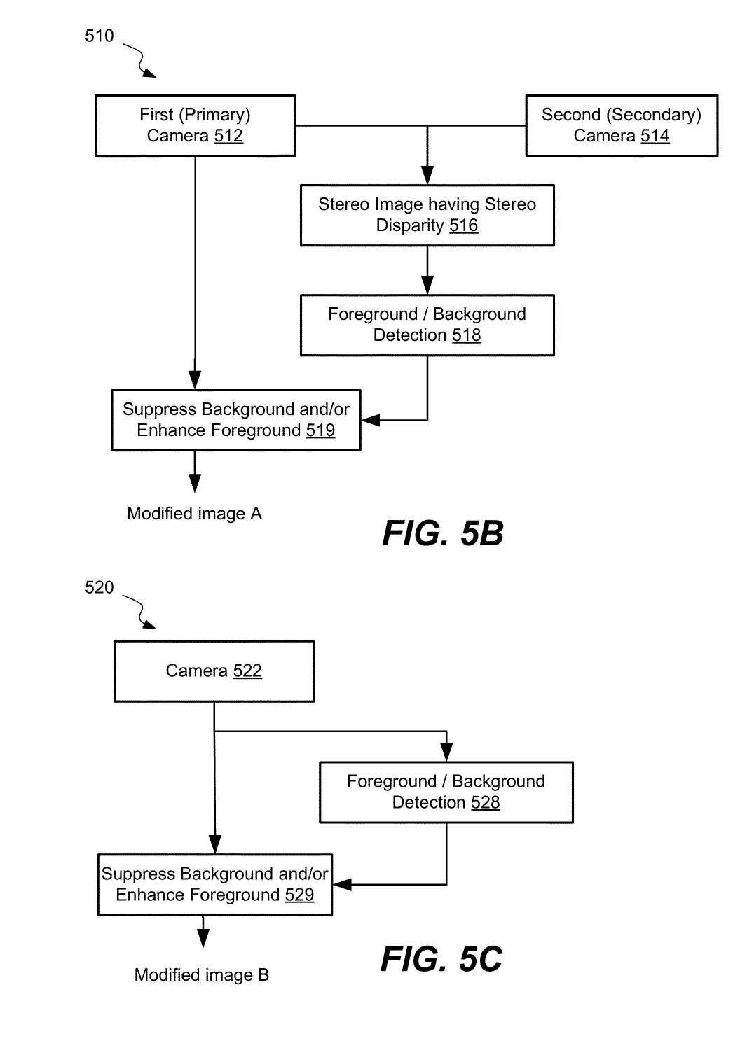

FIG. 5A is a schematic representation of various modules of an image capturing and processing device 500, in accordance with some embodiments. Specifically, device 500 includes a first camera 502, a processing module 506, and a data storage module 508. Device 500 may also include an optional second camera 504. One or both cameras 502 and 504 may be equipped with lenses having relatively small lens apertures that result in a large depth of field. As such, the background of the resulting image can be very distracting, competing for the viewer's attention since it may be hard to distinguish between close and distant objects. One or both of cameras 502 and 504 may have fixed-focus lenses that rely on sufficiently large depth of field to produce acceptably sharp images. Various details of camera positions are described above with reference to FIGS. 3-5.

Processing module 506 is configured for detecting at least one of a foreground portion or a background portion of the stereo image. Processing module 506 is also configured for processing at least one of the foreground portion and the background portion independently from each other. As noted above, the detecting operation separates the stereo image into at least the foreground portion and the background portion.

Data storage module 508 is configured for storing the stereo image, the processed images, and one or more settings used for the detecting and processing operations. Data storage module 508 may include a tangible computer memory, such as flash memory or other types of memory.

FIG. 5B is a schematic process flow 510 utilizing a device with two cameras 512 and 514, in accordance with some embodiments. Camera 512 may be a primary camera, while camera 514 may be a secondary camera. Cameras 512 and 514 generate a stereo image from which stereo disparity may be determined (block 516). This stereo disparity may be used for detection of background and foreground portions (block 518), which in turn is used for suppressing the background and/or enhancing foreground (block 519). The detection may be performed utilizing one or more cues, such as motion parallax (e.g., for video images), local focus, color grouping, and face detection, instead of or in addition to utilizing stereo disparity.

FIG. 5C is a schematic process flow 520 utilizing a device with one camera 522, in accordance with some embodiments. The image captured by this camera is used for detection of background and foreground portions (block 528). Instead of stereo disparity, various cues listed and described above may be used. One such cue is face detection. Based on detection of the background and foreground portions, one or more of these portions may be processed (block 529). For example, the background portion of the captured image may be suppressed to generate a new processed image. In the same or other embodiments, the foreground portion of the image is enhanced.

### Computer System Examples

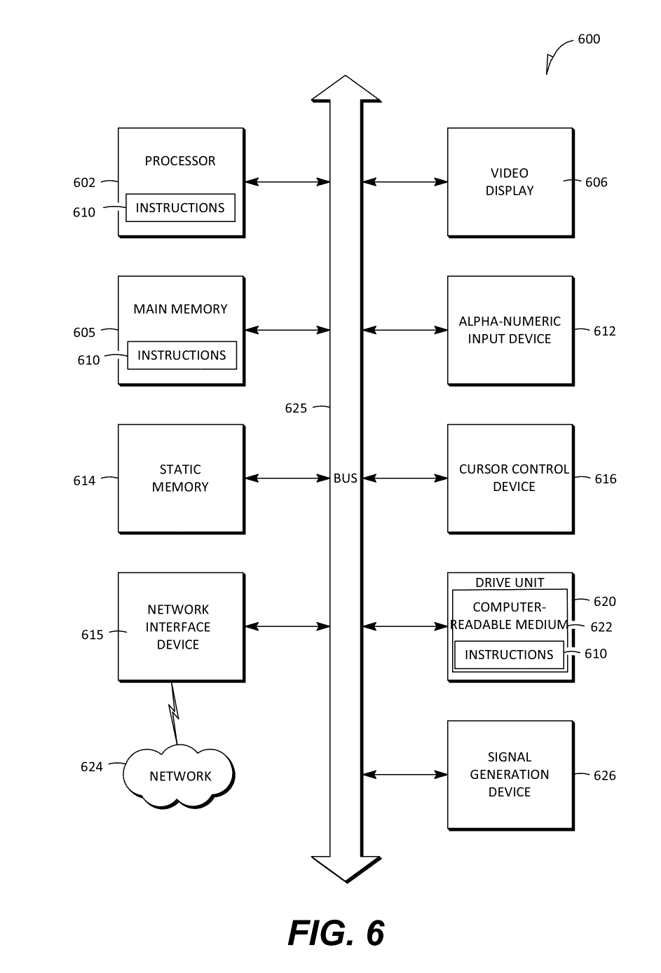

FIG. 6 is a diagrammatic representation of an example machine in the form of a computer system 600, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602 (e.g., a central processing unit (CPU), a graphics processing unit (GPU), or both), and a main memory 605 and static memory 614, which communicate with each other via a bus 625. The computer system 600 may further include a video display 606 (e.g., a liquid crystal display (LCD)). The computer system 600 may also include an alpha-numeric input device 612 (e.g., a keyboard), a cursor control device 616 (e.g., a mouse), a voice recognition or biometric verification unit (not shown), a drive unit 620 (also referred to as disk drive unit 620 herein), a signal generation device 626 (e.g., a speaker), and a network interface device 615. The computer system 600 may further include a data encryption module (not shown) to encrypt data.

The disk drive unit 620 includes a computer-readable medium 622 on which is stored one or more sets of instructions and data structures (e.g., instructions 610) embodying or utilizing any one or more of the methodologies or functions described herein. The instructions 610 may also reside, completely or at least partially, within the main memory 605 and/or within the processors 602 during execution thereof by the computer system 600. The main memory 605 and the processors 602 may also constitute machine-readable media.

The instructions 610 may further be transmitted or received over a network 624 via the network interface device 615 utilizing any one of a number of well-known transfer protocols (e.g., Hyper Text Transfer Protocol (HTTP)).

While the computer-readable medium 622 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer implemented method of processing an image, the method comprising:
detecting at least one of a foreground portion or a background portion of the image, wherein the detecting separates the image into at least the foreground portion and the background portion; and
processing at least one of the foreground portion and the background portion independently from each other.

2. The computer implemented method of claim 1, wherein the detecting comprises one or more techniques selected from the group consisting of motion parallax, local focus, color grouping, and face detection.

3. The computer implemented method of claim 1, wherein the image is a stereo image; and
wherein the detecting comprises analyzing the stereo disparity of the stereo image.

4. The computer implemented method of claim 3, wherein the detecting further comprises face detection.

5. The computer implemented method of claim 1, wherein the detecting comprises face detection.

6. The computer implemented method of claim 1, wherein the processing comprises one or more techniques selected from the group consisting of changing sharpness, changing color, suppressing, and changing saturation.

7. The computer implemented method of claim 1, wherein the processing comprises changing sharpness.

8. The computer implemented method of claim 7, wherein the changing sharpness comprises blurring using one or more blurring techniques including at least one of circular blurring and Gaussian blurring.

9. The computer implemented method of claim 7, wherein the changing sharpness comprises blurring the background portion of the image.

10. The computer implemented method of claim 9, wherein the foreground portion remains unchanged.

11. The computer implemented method of claim 9, wherein the changing sharpness further comprises sharpening the foreground portion of the image.

12. The computer implemented method of claim 1, wherein the image is a frame of a video.

13. The computer implemented method of claim 12, further comprising repeating the detecting and the processing for additional frames of the video.

14. The computer implemented method of claim 1, further comprising capturing the image using a single camera.

15. The computer implemented method of claim 14, wherein the detecting comprises one or more techniques selected from the group consisting of motion parallax, local focus, and color grouping.

16. The computer implemented method of claim 14, wherein the processing comprises face detection.

17. The computer implemented method of claim 1, further comprising capturing two images using two separate cameras provided on a same device, wherein the image comprises a combination of the two images.

18. The computer implemented method of claim 17, wherein the two cameras are positioned side by side within a horizontal plane.

19. The computer implemented method of claim 17, wherein the two cameras are separated by between about 30 millimeters and 150 millimeters.

20. A computer implemented method of processing an image, the method comprising:
capturing the image, wherein the image is a stereo image captured by two cameras provided on a device;
detecting at least one of a foreground portion or a background portion of the image based on stereo disparity of the stereo image,
wherein the detecting separates the image into at least the foreground portion and the background portion;
processing at least one of the foreground portion and the background portion independently from each other,
wherein processing comprises blurring the background portion of the image; and
displaying the processed image.

21. A device comprising:
a first camera;
a second camera,
a distance between the first camera and the second camera being between about 30 millimeters and 150 millimeters,
the first camera and the second camera being configured to capture a stereo image;
a processing module being configured for detecting at least one of a foreground portion or a background portion of the stereo image and for processing at least one of the foreground portion and the background portion independently from each other,
the detecting separating the stereo image into at least the foreground portion and the background portion; and
a storage module being configured for storing the stereo image, the processed images, and one or more settings used for the detecting and processing operations.

22. A computer implemented method of processing an image, the method comprising:
capturing two images using two separate cameras provided on a same device, wherein the image comprises a combination of the two images;
detecting at least one of a foreground portion or a background portion of the image, wherein the detecting separates the image into at least the foreground portion and the background portion, the image comprising stereo disparity, and wherein the detecting comprises:
face detection, and
analyzing the stereo disparity of the image; and
processing at least one of the foreground portion and the background portion independently from each other, wherein the processing comprises changing sharpness, the changing sharpness comprising:
blurring the background portion of the image, and
sharpening the foreground portion of the image.
